(19) United States
(12) Patent Application Publication
(10) Pub. No.: US 2020/0296595 A1
(43) Pub. Date: Sep. 17, 2020

(54) COMMUNICATION DEVICE AND METHOD

(71) Applicant: SZ DJI TECHNOLOGY CO., LTD., Shenzhen (CN)

(72) Inventors: Ning MA, Shenzhen (CN); Ying CHEN, Shenzhen (CN); Xingsen LIN, Shenzhen (CN)

(21) Appl. No.: 16/889,442

(22) Filed: Jun. 1, 2020

Related U.S. Application Data
(63) Continuation of application No. PCT/CN2018/074261, filed on Jan. 26, 2018.

(51) Int. Cl. H04W 16/14; H04W 24/10; H04B 17/336; H04W 74/08

(52) U.S. Cl. CPC H04W 16/14; H04W 74/0808; H04B 17/336; H04W 24/10

(57) ABSTRACT

The present disclosure provides a communication method and device. The method includes: effecting data communication at a first frequency channel of a first frequency band; and analyzing a second frequency channel substantially concurrently with effecting the data communication.

### CROSS-REFERENCE TO RELATED APPLICATION

This application is a continuation of International Application No. PCT/CN2018/074261, filed Jan. 26, 2018, the entire content of which is incorporated herein by reference.

### TECHNICAL FIELD

The present disclosure relates to communication technologies and, more particularly, to a communication device and method using multiple communication circuits.

### BACKGROUND

When a wireless communication system is working, analyzing of wireless resources is often performed, for example, in unlicensed spectrum. Interference is common in unlicensed spectrum, and has impact on efficiency and quality of wireless communication. Accordingly, communication systems working at the unlicensed spectrum often analyze all channels in the frequency band to identify a frequency channel that has less interference. By working on the identified frequency, a better communication quality can be achieved.

However, performing an analyzing process means a temporary interruption to a currently operating communication link of the wireless communication system. Correspondingly, there is a tradeoff between time assigned for the analyzing process and time assigned for working data communication. If more time is spent on the analyzing process, more accurate and timely result of channel analysis can be achieved, but the operating communication link is interrupted for a longer time, which can impact data transmission that require low delay and high bandwidth. If less time is spent on analyzing available channels, the accuracy of obtaining a proper channel is decreased. This is a technical problem that has been existing for a long time in the communication technology.

The disclosed method and system are directed to solve one or more problems set forth above and other problems.

### SUMMARY

In accordance with the present disclosure, there is provided a communication method. The method includes: effecting data communication at a first frequency channel of a first frequency band; and analyzing a second frequency channel substantially concurrently with effecting the data communication.

Also in accordance with the present disclosure, there is provided a communication device, including: a first communication circuit configured to effect data communication at a first frequency channel; and a second communication circuit configured to analyze a second frequency channel substantially concurrently with effecting the data communication.

### BRIEF DESCRIPTION OF THE DRAWINGS

FIG. 1 schematically shows frequency bands and frequency channels according to exemplary embodiments of the present disclosure;

FIG. 2 is a schematic block diagram showing an operating environment according to exemplary embodiments of the present disclosure;

FIG. 3 is a schematic block diagram of a communication device according to exemplary embodiments of the present disclosure;

FIG. 4 a schematic diagram showing a mobile object and a remote control according to an exemplary embodiment of the present disclosure;

FIG. 5 is a flow chart of a communication method according to an exemplary embodiment of the present disclosure;

FIG. 6 is a flow chart of an analyzing process according to an exemplary embodiment of the present disclosure;

FIG. 7 is a flow chart of an analyzing process according to an exemplary embodiment of the present disclosure;

FIG. 8 is a flow chart of a communication method according to an exemplary embodiment of the present disclosure; and

FIG. 9 is a flow chart of a communication method according to an exemplary embodiment of the present disclosure.

### DESCRIPTION OF THE EMBODIMENTS

Hereinafter, embodiments consistent with the disclosure will be described with reference to the drawings, which are merely examples for illustrative purposes and are not intended to limit the scope of the disclosure. Wherever possible, the same reference numbers will be used throughout the drawings to refer to the same or like parts.

The present disclosure is applicable to a method and a system that employs multiple communication standards, and working spectrum of the multiple communication standards have certain overlaps. Specifically, a communication method and device operating in multiple frequency channels in one or more frequency bands is provided.

A frequency band, as used herein, may refer to a range of the spectrum in radio communication frequencies. The frequency band may be referred to by its frequency range or its characteristic frequency, such as the central frequency, representative frequency, typical frequency, or most-frequently used frequency in the frequency band. For example, Wi-Fi networks primarily operate in the 2.4-GHz band and 5.8-GHz band. A frequency band can include multiple frequency channels. A frequency channel, as used herein, refers to a wireless communication channel that operates at a center frequency with a designated bandwidth. A frequency channel may be referred by a channel number/code in the frequency band that it belongs, or by its center frequency.

For example, in the U.S., eleven channels are designated in the 2.4 GHz band (ranging from 2.4 GHz to 2.5 GHz) for Wi-Fi communication, each having 22 MHz bandwidth, spaced 5 MHz apart from each other. For example, channel 1 of the 2.4 GHz band operates at a center frequency of 2.412 GHz, and its frequency ranges from 2.401 GHz to 2.423 GHz. Channel 2 of the 2.4 GHz band operates at a center frequency of 2.417 GHz, and its frequency ranges from 2.406 GHz to 2.428 GHz.

Further, two frequency channels may have overlapping frequency ranges. For example, in the 2.4 GHz band, channel 1 overlaps with channels 2-5, and does not overlap with channels 6-11.

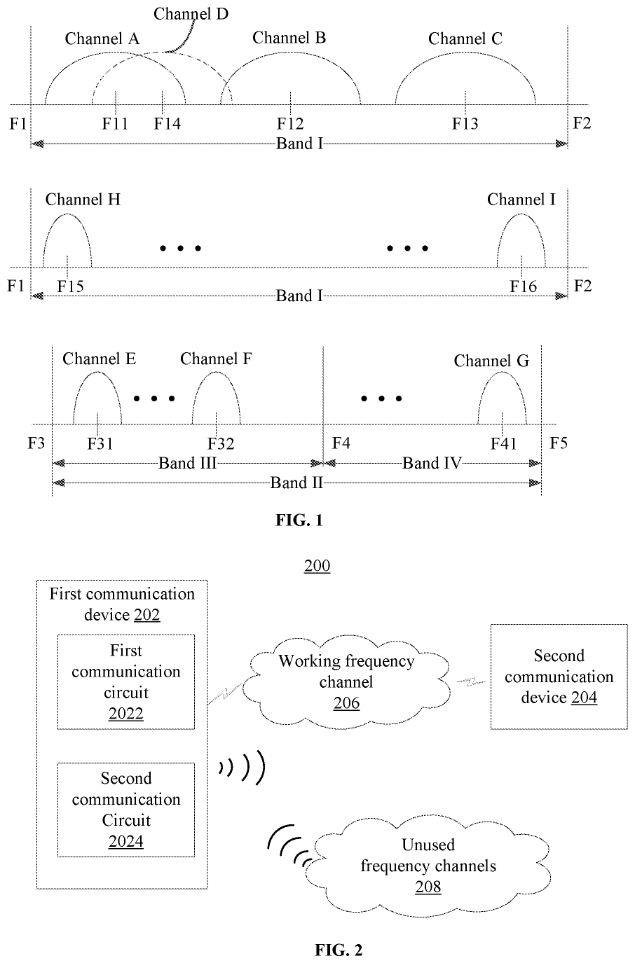

FIG. 1 schematically shows frequency channels and frequency bands in wireless communication according to exemplary embodiments of the present disclosure. A frequency band ranging from lower limit frequency F1 to upper limit frequency F2 (hereinafter Band I), a frequency band ranging from F3 to F5 (hereinafter Band II), a frequency band ranging from F3 to F4 (hereinafter Band III), and a frequency band ranging from F4 to F5 (hereinafter BAND IV) are shown. Frequency channels A, B, C, D, H, I, are included in Band I, and has a center frequency of F11, F12, F13, F14, F15, and F16 respectively. Frequency channels E, F, G are included in Band II, and has a center frequency of F31, F32, and F41 respectively. In addition, frequency channels E and F are included in Band III, and frequency channel G is included in Band IV. Further, channels A, B, C are non-overlapping channels. Channel D overlaps with both channel A and channel B. Channel A and Channel H overlaps, and Channel I and Channel C overlaps.

In the disclosed embodiments, channels shown in FIG. 1 may be used as illustrative examples, and relationships among the channels (i.e., overlapping situations and whether two channels belong to a same frequency band) are, unless otherwise specified, consistent throughout the disclosure.

When wireless signals are transmitted at a certain frequency channel, communication quality can be affected by interference from channel(s) overlapping with the certain frequency channel. For communication devices operating in a spectrum that is designated as unlicensed, where there is no exclusive use of the spectrum, channel interference may become a common problem.

The communication quality or channel performance/condition at a frequency channel can be measured by various parameters, such as, a throughput, a signal-to-noise ratio (SNR), a signal-to-noise-plus-interference ratio (SNIR), a bit error rate (BER), a channel quality indicator (CQI), a transmission latency, a channel bandwidth, or the like. Analyzing or scanning a frequency channel, or channel analysis, as used herein, may refer to evaluating channel condition and communication quality of the frequency channel based on measurements of these parameters.

A wireless communication circuit, also referred to as a “communication circuit” as used herein, has the capacity to detect/analyze conditions at multiple frequency channels in one or more frequency bands (i.e., perform an analyzing process to measure one or more of the above-mentioned parameters related to the channel performance), select a desired channel accordingly, and effect data communication on the selected channel based on a communication protocol. The wireless communication circuit can operate at one frequency channel at a time. In other words, when the wireless communication circuit is analyzing a frequency channel, the wireless communication circuit may not simultaneously analyze a different frequency channel or effect data communication at a different frequency channel, and vice versa.

In a communication system that includes at least two communication circuits, a desired communication circuit is selected adaptively for data communication. In existing technologies, while the selected communication circuit is operating, the other unselected communication circuit does not operate at all at the same time. In other words, in the existing technologies, the operating communication circuit needs to perform both channel analyzing process and working data communication. Consistent with the present disclosure, two communication circuits have an overlapping operating frequency range may operate at the same time. For example, one of the communication circuits can perform working data communication and can be referred to as an “operating communication circuit.” Meanwhile, the other one of the communication circuits can analyze the overlapping range and can be referred to as an “unselected communication circuit.”

FIG. 2 is a schematic block diagram showing an operating environment 200 according to exemplary embodiments of the present disclosure. As shown in FIG. 2, the exemplary operating environment 200 includes a first communication device 202 and a second communication device 204. The first communication device 202 may effect data communication with the second communication device 204 at a working frequency channel 206. That is, the first communication device 202 may transmit and receive working data to and from the second communication device 204 through the working frequency channel 206. The working data can include, for example, monitoring information and/or controlling information for the first communication device 202 and/or the second communication device 204. The first communication device 202 may further perform an analyzing process on unused frequency channels 208 (i.e., frequency channels that are different from the working frequency channel 206 and potential operations at such channels are supported by the first communication device 202). That is, the first communication device 202 may analyze one of the unused frequency channels 208 substantially concurrently with effecting the data communication at the working frequency channel 206. For example, the first communication device 202 may analyze one of the unused frequency channels 208 during, shortly before (e.g., within about 1 millisecond before), or shortly after (e.g., within about 1 millisecond after) the data communication.

Based at least in part on the analyzing result, the first communication device 202 may determine that one of the unused frequency channels 208 (e.g., Channel A) is a more desirable channel than the current working frequency channel 206 (e.g., Channel E) for data communication with the second communication device 204. In some embodiments, the first communication device 202 may switch to the desired channel (e.g., Channel A) to continue the data communication. That is, the working frequency channel 206 is updated to the desired channel (e.g., Channel A), and the previously used working frequency channel (e.g., Channel E) becomes one of the unused frequency channels 208.

Specifically, the first communication device 202 includes a first communication circuit 2022 and a second communication circuit 2024. The first communication circuit 2022 and the second communication circuit 2024 may support same or different wireless communication standards/protocols. For example, one of the first communication circuit 2022 and the second communication circuit 2024 may implement a standard public communication protocol (e.g., Wi-Fi IEEE 802.11 standard or WiMAX IEEE 802.16 standard), and the other one may implement a private communication technology such as software defined radio (SDR) protocol. Any proper communication protocols may be supported by the communication circuits 2022 and 2024, such as SDR, Wi-Fi, Bluetooth, Zigbee, LTE, GPRS, GSM, CDMA, etc.

Each of the first communication circuit 2022 and the second communication circuit 2024 can, for example, be a chip or part of the chip including an integrated circuit. The first communication circuit 2022 and the second communication circuit 2024 may be located in a same housing in the first communication device 202, or separately at different parts of the first communication device 202. In some embodiments, the first communication device 202 further includes an internal data exchange mechanism/interface between the first communication circuit 2022 and the second communication circuit 2024. That is, the first communication circuit 2022 and the second communication circuit 2024 are connected to each other directly or indirectly such that scanning/analyzing result and channel information can be communicated between the first communication circuit 2022 and the second communication circuit 2024, and a desired channel can be selected accordingly. The connection interface between the first communication circuit 2022 and the second communication circuit 2024 can be any interface that is suitable for coupling two circuits. For example, the connection interface can be a Universal Serial Bus (USB) interface, a High-Definition Multimedia Interface (HDMI), or a wireless link, such as a Wi-Fi link, a Bluetooth link, or a near-field communication link.

The first communication circuit 2022 is configured to operate at one or more first frequency bands. The second communication circuit 2024 is configured to operate at one or more second frequency bands. An overlap exists between at least one of the one or more first frequency bands and at least one of the one or more second frequency bands. Hereinafter, such an overlap is referred to as an overlapping frequency range. In one example, the first communication circuit 2022 may be configured to operate at Band I and Band II described above, and the second communication circuit 2024 may be configured to operate at Band I or Band III. In another example, the first communication circuit 2022 and the second communication circuit 2024 may be both configured to operate at one band (e.g., Band II), or two bands (e.g., Band I and III). In another example, the first communication circuit 2022 may be configured to operate at Band I and Band III, and the second communication circuit 2024 may be configured to operate at Band I and Band II. That is, the one or more first frequency bands may include the one or more second frequency bands, be the same as the one or more second frequency bands, or be included in the one or more second frequency bands.

Further, in some embodiments, the one or more first frequency bands and the one or more second frequency bands are within the unlicensed spectrum. For example, in examples related to FIG. 1, Band I may be the 2.4 GHz band approved by Federal Communications Commission (FCC) of the U.S., Band II may be the 5 GHz band approved by FCC, and Band III may be included in Band II and range from 5.17 GHz to 5.33 GHZ, i.e., Band III may be a sub-band of Band II.

In an exemplary embodiment, the first communication device 202 is configured to, when one of the first communication circuit 2022 and the second communication circuit 2024 is performing working data communication, instruct the other one of the first communication circuit 2022 and the second communication circuit 2024 to perform an analyzing process for unused channels included in the overlapping frequency range. For illustrative purposes, the first communication circuit 2022 is considered as the one performing the working data communication, and the second communication circuit 2024 is considered as the one performing the analyzing process for the frequency channels in the overlapping frequency range. That is, having two communication circuits operating at the same time for different purposes, the first communication device 202 can achieve analyzing the unused frequency channels 208 (e.g., by the second communication circuit 2024) substantially concurrently with effecting data communication with the second communication device 204 at the working frequency channel 206 (e.g., by the first communication circuit 2022).

That is, the first communication circuit 2022 is configured to perform working data communication with the second communication device 204 at a first frequency channel (e.g., the working frequency channel 206). The second communication circuit 2024 is configured to analyze a second frequency channel that is different from the first frequency channel (e.g., one of the unused frequency channels 208). Specifically, the first frequency channel (e.g., Channel A) is in a first frequency band (e.g., Band I), and the second frequency channel is one of: a frequency channel (e.g., one of Channels B, C, D) in the first frequency band other than the first frequency channel, or a frequency channel (e.g., one of Channels E, F, G) in a second frequency band (e.g., Band II) different from the first frequency band. In some embodiments, the second communication circuit 2024 is configured to analyze a plurality of frequency channels within the overlapping frequency range.

For example, the first communication circuit 2022 supports Wi-Fi communication at both the 2.4 GHz band and the 5.8 GHz band, and the second communication circuit 2024 supports SDR communication at both the 2.4 GHz band and the 5.8 GHz band. When the first communication circuit 2022 is operating at the 2.4 GHz band, i.e., performing working data communication with the second communication device 204 at the 2.4 GHz band, the second communication circuit 2024 can be used for analyzing one or more channels at the 5.8 GHz band and/or one or more frequency channels at the 2.4 GHz band other than the working frequency channel 206.

In some embodiments, the first communication device 202 may be further configured to assign the first communication circuit 2022 to analyze a first group of the unused frequency channels 208 and assign the second communication circuit 2024 to analyze a second group of the unused frequency channels 208. In some embodiments, channels supported by the first communication circuit 2024 and not included in the overlapping frequency range may be included in the first group of the unused frequency channels 208. In some embodiments, the first group of the unused frequency channels 208 may be an empty group, i.e., all of the unused frequency channels 208 may be in the second group and the first communication circuit 2022 does not perform channel analysis. In some embodiments, channels supported by the second communication circuit 2022 and not included in the overlapping frequency range may or may not be included in the second group of the unused frequency channels 208.

For example, the first communication circuit 2022 may operate at Bands I and III as shown in FIG. 1, while the second communication circuit 2024 may operate at Bands I and IV. That is, the overlapping frequency range in this case is from F1 to F2. Accordingly, channels assigned to be analyzed by the first communication circuit 2022 include channels in Band III (e.g., Channels E and F). The second communication circuit 2024 may be assigned to analyze some or all channels in Band I and IV. For example, when the first communication circuit 2022 is performing the working data communication at a first channel in a first band (e.g., Channel E in Band III), the second communication circuit 2024 may be assigned to analyze one or more channels (e.g., Channels A-D or just Channels B and C) in the overlapping range that are not included in the first band, and/or one or more channels (e.g., Channel G) not overlapping with the first channel.

Consistent with the disclosure, analyzing by the second communication circuit 2024 of channels in the overlapping frequency ranges can reduce or eliminate time spent by the first communication circuit 2022 on analyzing the same channels. If the second communication circuit 2024 can operate at all channels supported by the first communication circuit 2022, analyzing process performed by the first communication circuit 2022 may be eliminated entirely.

In some embodiments, a first communication protocol implemented in the first communication circuit 2022 and a second communication protocol implemented in the second communication circuit 2024 may have different configurations/designations of channels in a same frequency band (e.g., configurations of Channels A-D in Band I by one protocol are different from that of Channels H and I in Band I by another protocol). For example, the first communication protocol may define its channels to have a first bandwidth (e.g., 20 MHz) and a first channel separation value (5 MHz) between center frequencies of each pair of adjacent channels. The second communication protocol may define its channels to have a second bandwidth (e.g., 10 MHz) and a second channel separation value (2 MHz) between center frequencies of each pair of adjacent channels. That is, in a same frequency band having a range of 40 MHz, the first communication protocol may define 5 channels, while the second communication protocol may define 16 channels.

Accordingly, the second communication circuit 2024 may be further configured to obtain channel configuration information of frequency channel(s) based on a communication protocol employed by the first communication circuit 2022, and analyze the second frequency channel or the plurality of frequency channels based on the channel configuration information. In other words, if the channel designation of a first communication standard employed by the first communication circuit 2022 is not consistent with the channel designation of a second communication standard employed by the second communication circuit 2024, the second communication circuit 2024 may analyze channels in accordance with the first communication standard. The channel configuration information may include, for example, center frequency of each to-be-analyzed channel, bandwidth of each to-be-analyzed channel, and/or number of to-be-analyzed channels. Here, the to-be-analyzed channel(s) refer to channel(s) to be analyzed by the second communication circuit 2024, i.e., channels included in both the second group of the unused frequency channels 208 and the overlapping frequency range.

In some embodiments, the first communication device 202 is further configured to determine that the second frequency channel (i.e., a to-be-analyzed channel) is in a same frequency band as that of the first frequency channel (e.g., the working frequency channel 206), obtain a time that the first communication circuit 2022 sends out data, and analyze the second frequency channel according to the obtained time.

In some embodiments, the first communication device 202 is further configured to determine that the second frequency channel overlaps with the first frequency channel, obtain a time that the first communication circuit 2022 sends out data, and analyze the second frequency channel according to the obtained time.

Sometimes, the first communication circuit 2022 and the second communication circuit 2024 may respectively operate at two frequency channels that overlap each other or that are in a same frequency band. In this scenario, if the second communication circuit 2024 receives a scanning-related signal (i.e., data signal related to channel analysis) at a same time as the first communication circuit 2022 sends out data, the scanning-related signal and the data sent by the first communication circuit 2022 may interfere with each other, and the second communication circuit 2024 may receive a mixture of the scanning-related signal and the data sent by the first communication circuit 2022, which may cause inaccurate evaluation of corresponding channel condition. In some embodiments, the second communication circuit 2024 can be configured to perform the analyzing process based on a time that the first communication circuit 2022 sends out data, thereby avoiding saturation at the second communication circuit 2024, ensuring accuracy of the analyzing process, and avoiding interference with working data communication.

Different strategies can be employed by the second communication circuit 2024 to perform the analyzing process based on the time that the first communication circuit 2022 sends out data. For example, the second communication circuit 2024 can pause the analyzing of the second frequency channel at the obtained time. As another example, the second communication circuit 2024 can analyze, at the obtained time, a third frequency channel that does not overlap with the first frequency channel. The third frequency channel can be in a different frequency band than the first frequency band including the first frequency channel, or can be also in the first frequency band but not overlapping with the first frequency channel. As a further example, the second communication circuit 2024 can discard information obtained for channel analysis at the obtained time.

In some embodiments, collaboration between the first communication circuit 2022 and the second communication circuit 2024 can be implemented using software and/or hardware to allow the second communication circuit 2024 to obtain the time that the first communication circuit 2022 sends out data. For example, clocks of the first communication circuit 2022 and the second communication circuit 2024 may be synchronized.

The analyzing process for the second frequency channel includes measuring interference at the second frequency channel. Various parameters may be measured to characterize the interference. Further, automatic channel selection (ACS), clear channel assessment (CCA) and/or dynamic frequency selection (DFS) may also be performed during the analyzing process. Any proper spectral analysis techniques may be utilized in the analyzing process for evaluating the channel condition.

In some embodiments, the second communication circuit 2024 is configured to obtain an analyzing result of the second frequency channel. Further, the first communication circuit 2022 can obtain information about the first frequency channel during the working data communication. The first communication device 202 may compare the analyzing result of the second frequency channel and the information about the first frequency channel, select one of the first frequency channel or the second frequency channel based at least in part on the analyzing result, and effect the data communication at the selected frequency channel.

In some embodiments, the first communication circuit 2022 is configured to send the information about the first frequency channel to the second communication circuit 2024, and the comparison and selection between the first frequency channel and the second frequency channel can be made by the second communication circuit 2024. In some other embodiments, the second communication circuit 2024 is configured to send the analyzing result to the first communication circuit 2022, and the comparison and selection between the first frequency channel and the second frequency channel can be performed by the first communication circuit 2022.

In some embodiments, when the plurality of frequency channels within the overlapping frequency range are analyzed and multiple analyzing results are obtained, the second communication circuit 2024 can select a candidate frequency channel from the plurality of analyzed frequency channels based on the multiple analyzing results. Accordingly, the second communication circuit 2024 may compare the candidate frequency channel with the first frequency channel, and determine whether to switch to the candidate frequency channel for performing the working data communication based on information about the candidate frequency channel and the information about the first frequency channel. In some other embodiments, the second communication circuit 2024 may send the information about the candidate frequency channel to the first communication circuit 2022 for the first communication circuit 2022 to make the switching decision.

In some embodiments, in determining whether to switch to another frequency channel, besides values of parameters of related channels, preconfigured standards and/or communication cost and resources spent on the switching action may also be considered. For example, preconfigured thresholds for interference parameters may be used to filter out channels that may have poor performance at a specific aspect. Further, weights may be assigned to different types of parameters and an overall evaluation of a channel may be obtained accordingly.

After a frequency channel is selected based at least in part on the analyzing result(s), the first communication device 202 can effect the working data communication at the selected frequency channel using the first communication circuit 2022 or the second communication circuit 2024. In some embodiments, the first communication device 202 may determine one of the communication circuits to effect the working data communication at the selected frequency channel. In one example, when the selected frequency channel is the first frequency channel, i.e., unchanged, the first communication circuit 2022 may continue performing the working data communication at the first frequency channel. In another example, when the selected frequency channel is the second frequency channel and the first communication circuit 2022 does not support operation at the second frequency channel, the second communication circuit 2024 may continue performing the working data communication at the second frequency channel.

FIG. 3 is a schematic block diagram of the first communication device 202 according to exemplary embodiments of the present disclosure. As shown in FIG. 3, the first communication device 202 includes at least one processor 2026, at least one memory 2027, and at least one wireless transceiver 2028, which implement the first communication circuit 2022 and the second communication circuit 2024. According to the disclosure, the at least one processor 2026, the at least one memory 2027, and the at least one wireless transceiver 2028 can be separate devices, or any two or more of them can be integrated in one device. In some embodiments, the first communication circuit 2022 and the second communication circuit 2024 may each include a set of processor, memory, and wireless transceiver. In some other embodiments, the first communication circuit 2022 and the second communication circuit 2024 may share a same processor, memory, and/or wireless transceiver. In some embodiments, the first communication device 202 may include additional processor, memory, connection interface, and/or other hardware components for coordinating collaborations between the first communication circuit 2022 and the second communication circuit 2024.

In some embodiments, the at least one wireless transceiver 2028 is configured to operate at the working frequency channel 206 for transmitting and receiving working data to and from the second communication device 204, and operate at the unused frequency channels 208 for transmitting and receiving data related to channel sniffing (e.g., channel condition analysis and measurement). The at least one wireless transceiver 2028 is controlled by the at least one processor 2026, and includes one or more antennas.

The at least one processor 2026 can include any suitable hardware processor, such as a microprocessor, a micro-controller, a central processing unit (CPU), a network processor (NP), a digital signal processor (DSP), an application specific integrated circuit (ASIC), a field-programmable gate array (FPGA), or another programmable logic device, discrete gate or transistor logic device, discrete hardware component. The at least one memory 2027 stores computer program codes that, when executed by the processor, control the processor to control the first communication device 202, the first communication circuit 2022, the second communication circuit 2024 and/or the wireless transceiver 2028 to perform a communication method consistent with the disclosure, such as one of the exemplary communication methods described below. In some embodiments, the computer program codes also control the processor to perform some or all of the functions that can be performed by the first communication device 202 described above.

For example, the processor 2026, coupled to the memory 2027 and the wireless transceiver 2028, may be configured to obtain channel information through channel estimation. The channel information may include, but is not limited to, e.g., the SNR, SNIR, BER, CQI, transmission latency, channel bandwidth, and/or the like. The channel information can be estimated using pilot data and/or received data based on different channel estimation schemes. The pilot data refers to a data pattern transmitted with data and known to both the first communication device 202 and the second communication device 204. The channel estimation scheme can be chosen according to the required performance, computational complexity, time-variation of the channel, and/or the like.

For example, training-based channel estimation uses the pilot data for channel estimation, which provides good performance but the transmission efficiencies are reduced due to the required overhead of pilot data. The least square (LS) and the minimum mean square error (MMSE) are generally used for determining a channel estimate Ĥ. The LS estimates the channel estimate Ĥ by minimizing the sum of the squared errors between the pilot data and the received pilot data. The MMSE estimates the channel estimate Ĥ by minimizing the mean square error (MSE). The channel parameters, such as the SNR, SNIR, BER, FER, CQI, and/or the like, can be calculated based on the channel estimate Ĥ.

The at least one memory 2027 can include a non-transitory computer-readable storage medium, such as a random-access memory (RAM), a read only memory, a flash memory, a volatile memory, a hard disk storage, or an optical medium. The at least one memory 2027 coupled to the processor may be configured to store instructions and/or data. For example, the memory 2027 may be configured to store information related to communication standards supported by the first communication device 202, computer executable instructions for implementing the analyzing process and data communication process, or the like. The processor can be any type of processor and the memory can be any type of memory. The disclosure is not limited thereto.

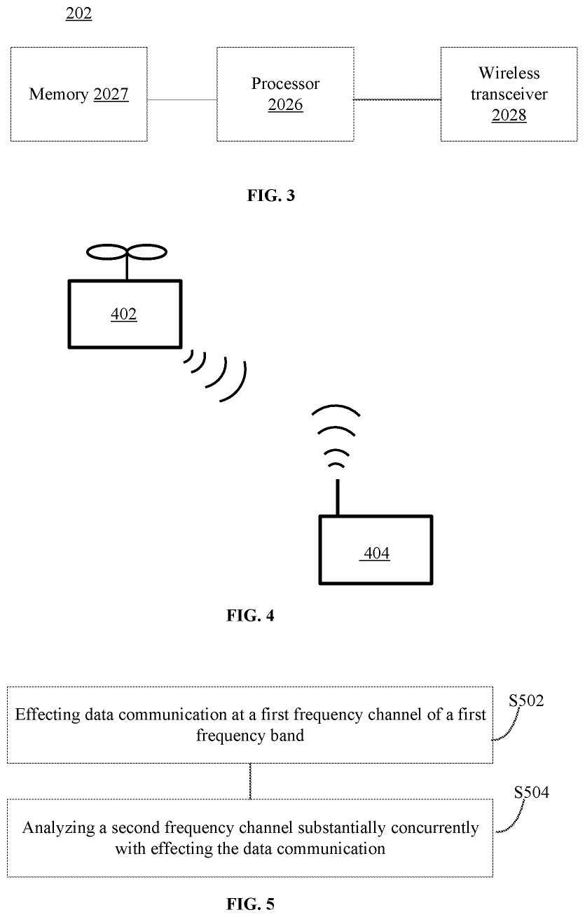

FIG. 4 a schematic diagram showing a mobile object 402 and a remote control 404 according to an exemplary embodiment of the present disclosure. The mobile object 402 can be, for example, an unmanned aerial vehicle (UAV), a driverless car, a mobile robot, a driverless boat, a submarine, a spacecraft, a satellite, or the like. In some embodiments, the first communication device 202 may be the mobile object 402 or may be integrated in the mobile object 402. The remote control 404 may be a remote controller or a terminal device with an application (app) that can control the first communication device 202 and/or the mobile object 402. The terminal device can be, for example, a smartphone, a tablet, a game device, or the like. The second communication device 204 may be the remote control 404 or may be integrated in the remote control 404.

In some other embodiments, the second communication device 204 may be a hosted payload carried by the mobile object 402 that operates independently but may share the power supply of the mobile object 402. In some other embodiments, the second communication device 204 may be provided in another mobile object, such as a UAV, a driverless car, a mobile robot, a driverless boat, a submarine, a spacecraft, a satellite, or the like.

In some other embodiments, the second communication device 204 may be integrated in the mobile object 402, and the first communication device 202 may be integrated in the remote control 404, the payload, or the other mobile object.

The present disclosure further provides a communication method applicable to a communication device that includes two communication circuits. FIGS. 5-9 are flow charts depicting various embodiments of the disclosed communication method. The disclosed method may be implemented by the first communication device 202 in accordance with FIG. 2 and/or FIG. 3 described above.

FIG. 5 is a flow chart of a communication method according to an exemplary embodiment of the present disclosure. The method includes: effecting data communication at a first frequency channel of a first frequency band (S502); and analyzing a second frequency channel substantially concurrently with effecting the data communication (S504).

In some embodiments, the effecting is implemented by a first communication circuit of a communication device; and the analyzing is implemented by a second communication circuit of the communication device. In some embodiments, effecting the data communication may include transmitting to and receiving from a linked device, working data related to the communication device at the first frequency channel. The linked device refers to a device that is wirelessly connected to the first communication circuit. For example, the communication device can be the first communication device 202 shown in FIG. 2 and the linked device can be the second communication device 204 shown in FIG. 2. The working data related to the communication device may include monitoring information and/or controlling information of at least one of the communication device, an object that integrates the communication device, an object that is connected to the communication device, the linked device, an object that integrates the linked device, or an object that is connected to the linked device.

Further, the first frequency channel is in the first frequency band, and the second frequency channel is a frequency channel in the first frequency band other than the first frequency channel, or a frequency channel in a second frequency band that is different from the first frequency band.

In some embodiments, the communication device may store a first list of frequency channels supported by the first communication circuit and corresponding channel information, and a second list of frequency channels supported by the second communication circuit and corresponding channel information. The method may further include, before analyzing the second frequency channel, determining at least one to-be-analyzed channel for the second communication circuit based on information about the first frequency channel, the channel information about the frequency channels supported by the first communication circuit, and information about frequency channels supported by the second communication circuit. The at least one to-be-analyzed channel includes the second frequency channel.

In one embodiment, the at least one to-be-analyzed channel for the second communication circuit may include at least one frequency channel in a frequency range supported by both the first communication circuit and the second communication circuit (i.e., the overlapping frequency range). In another embodiment, the at least one to-be-analyzed channel for the second communication circuit may include at least one frequency channel that is included in the overlapping frequency range and is not included in a frequency band that the first frequency channel belongs to. In yet another embodiment, the at least one to-be-analyzed channel for the second communication circuit may include at least one frequency channel that is included in the overlapping frequency range and does not overlap with the first frequency channel.

In some embodiments, the at least one to-be-analyzed channel for the second communication circuit may further include at least one frequency channel that is supported by the second communication circuit but not supported by the first communication circuit. In some embodiments, the method may further include analyzing, by the first communication circuit, a third frequency channel that is different from the first frequency channel and is not supported by the second communication circuit.

In some embodiments, the communication device is integrated in a movable object. The working data may include data collected by sensors onboard the movable object (such as image data, GPS data, movement data, power level) and/or operation commands from the linked device (such as adjusting moving path, adjusting posture/position, operation to payload, zooming in/out an onboard camera, powering on/off an onboard sensor).

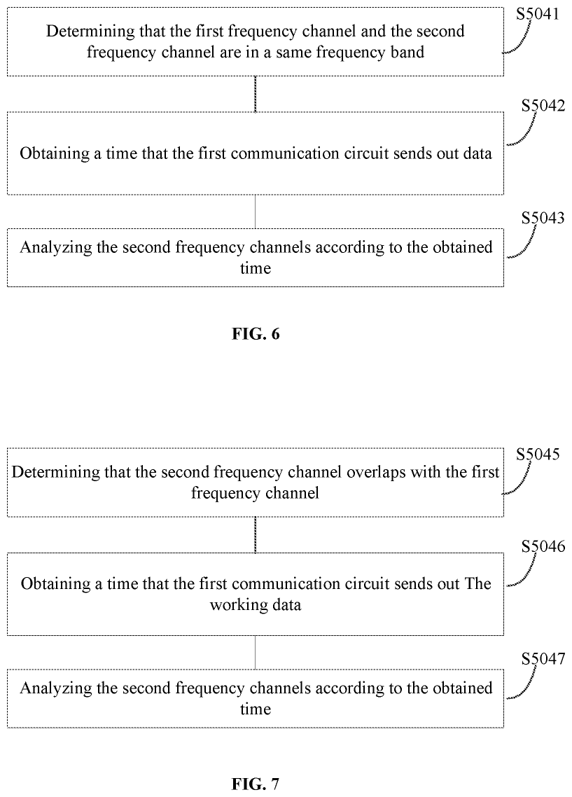

FIG. 6 and FIG. 7 are flow charts of two exemplary analyzing processes according to exemplary embodiments of the present disclosure. In some embodiments, as shown in FIG. 6, analyzing the second frequency channel (S504) includes: determining that the first frequency channel and the second frequency channel are in a same frequency band (S5041); obtaining a time that the first communication circuit sends out data (S5042); and analyzing the second frequency channel according to the obtained time (S5043).

In some embodiments, when the at least one to-be-analyzed channel for the second communication circuit is determined, and if the second communication circuit supports operation at a frequency band that the first frequency channels belongs to, the method may further include: identifying one or more frequency channels that are in the same frequency band as the first frequency channel based on the information about the frequency channels supported by the first communication circuit and the information about frequency channels supported by the second communication circuit. In these embodiments, determining that the first frequency channel and the second frequency channel are in the same frequency band (S5041) can include determining that the second frequency channel is included in the one or more identified frequency channels.

In some other embodiments, as shown in FIG. 7, analyzing the second frequency channel (S504) includes: determining that the first frequency channel overlaps with the second frequency channel (S5045); obtaining a time that the first communication circuit sends out data (S5046); and analyzing the second frequency channel according to the obtained time (S5047).

In some embodiments, when the at least one to-be-analyzed channel for the second communication circuit is determined, and if the second communication circuit supports operation at a frequency band that the first frequency channels belongs to, the method may further include: identifying one or more frequency channel that overlaps with the first frequency channel based on the information about the frequency channels supported by the first communication circuit and the information about frequency channels supported by the second communication circuit. In these embodiments, determining that the second frequency channel overlaps with the first frequency channel (S5045) can include determining that the second frequency channel is included in the one or more identified frequency channels.

FIG. 8 is a flow chart of a communication method according to an exemplary embodiment of the present disclosure. As shown in FIG. 8, the method includes: effecting data communication at a first frequency channel of a first frequency band(S802); and analyzing a second frequency channel substantially concurrently with effecting the data communication (S804). Processes S802 and S804 may be implemented in a similar manner as processes S502 and S504 described above.

As shown in FIG. 8, the method further includes: obtaining an analyzing result from the analyzing of the second frequency channel (S806); selecting a frequency channel based at least in part on the analyzing result (S808); and effecting data communication at the selected frequency channel (S810).

In some embodiments, the method may further include: obtaining the analyzing result from analyzing of (e.g., by the second communication circuit) a plurality of frequency channels that are different from the first frequency channel. In some embodiments, selecting the frequency channel (S808) may include: selecting a candidate frequency channel (e.g., the second frequency channel) from the analyzing of the plurality of frequency channels based at least in part on the analyzing result; and comparing the candidate frequency channel with the first frequency channel to determine the selected frequency channel. In some other embodiments, selecting the frequency channel (S808) may include consecutively comparing some or all of the plurality of analyzed frequency channels with the first frequency channel to determine the selected frequency channel.

In some embodiments, the selected frequency channel may be the first frequency channel. Accordingly, the first communication circuit does not need to switch channel and the data communication can be continued by the first communication circuit at the first frequency channel. In some other embodiments, the selected frequency channel may be the second frequency channel. Accordingly, the method may further include switching to the second frequency channel to continue effecting the data communication. For example, the first communication circuit may inform the linked device about the channel switching and obtain acknowledgement from the linked device. Connection with the linked device at the second frequency channel can be established and data communication can be continued at the second frequency channel. The data communication at the second frequency channel may be performed by the first communication circuit or the second communication circuit based on application scenarios.

In some embodiments, after the frequency channel is selected, the communication method may further include analyzing a third frequency channel different from the selected frequency channel. In some embodiments, when one of the first communication circuit and the second communication circuit performs the data communication at the selected frequency channel, the other one of the first communication circuit and the second communication circuit can analyze the third frequency channel.

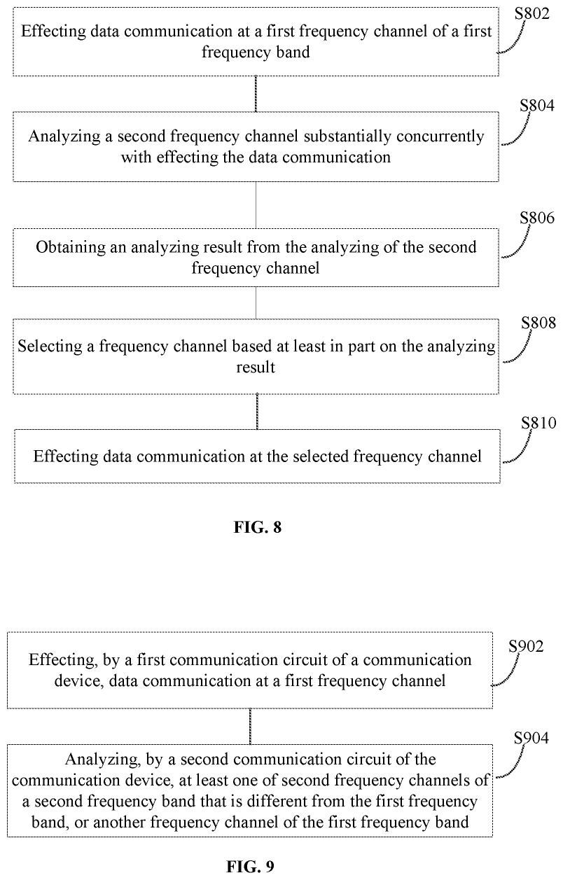

FIG. 9 is a flow chart of a communication method according to another exemplary embodiment of the present disclosure. As shown in FIG. 9, the method includes: effecting, by a first communication circuit of a communication device, data communication at a first frequency channel (S902); and analyzing, by a second communication circuit of the communication device, at least one of second frequency channels of a second frequency band that is different from the first frequency band, or another frequency channel of the first frequency band (S904).

In some embodiments, the method may further include: obtaining, by the second communication circuit, an analyzing result of the at least one of the second frequency channels of the second frequency or the another frequency channel of the first frequency band; selecting a frequency channel among frequency channels analyzed by the second communication circuit and the first frequency channel based on the analyzing result and information about the first frequency channel; and effecting the data communication at the selected frequency channel.

In some embodiments, selecting the frequency channel can include selecting, by the second communication circuit, a candidate frequency channel among the frequency channels analyzed by the second communication circuit based on the analyzing result; and comparing the candidate frequency channel with the first frequency channel to determine the selected frequency channel.

Therefore, consistent with the disclosure, quick and accurate scanning/analyzing of unused frequency channels can be achieved without occupying resources (e.g., time and/or duty cycle) for data communication at the working frequency channel, which solves the trade-off problem in existing technologies. Further, based on the analyzing results, the disclosed communication device can operate a channel with less interference and high communication quality. Such application is particularly useful in communication system involving a mobile object. As the mobile object moves in space, channel condition in the working frequency channel and the unused frequency channels may vary greatly. Accordingly, the disclosed method and device utilizes idle communication circuit for evaluating channel condition, and adaptively selects a more desirable frequency channel, thereby improving communication quality and efficiency.

The processes shown in the figures associated with the method embodiments can be executed or performed in any suitable order or sequence, which is not limited to the order and sequence shown in the figures and described above. For example, two consecutive processes may be executed substantially simultaneously where appropriate or in parallel to reduce latency and processing time, or be executed in an order reversed to that shown in the figures, depending on the functionality involved.

Further, the components in the figures associated with the device embodiments can be coupled in a manner different from that shown in the figures as needed. Some components may be omitted and additional components may be added.

Other embodiments of the disclosure will be apparent to those skilled in the art from consideration of the specification and practice of the embodiments disclosed herein. It is intended that the specification and examples be considered as exemplary only and not to limit the scope of the disclosure, with a true scope and spirit of the invention being indicated by the following claims.

What is claimed is:

1. A method for analyzing a wireless channel, comprising:
effecting data communication at a first frequency channel of a first frequency band; and
analyzing a second frequency channel substantially concurrently with effecting the data communication.

2. The method of claim 1, further comprising:
obtaining an analyzing result from the analyzing of the second frequency channel;
selecting a frequency channel based at least in part on the analyzing result; and
continuing the data communication at the selected frequency channel.

3. The method of claim 2, wherein selecting the frequency channel comprises:
selecting a candidate frequency channel based at least in part on the analyzing result; and
comparing the candidate frequency channel with the first frequency channel to determine the selected frequency channel.

4. The method of claim 2, further comprising:
after selecting the frequency channel, analyzing a third frequency channel different from the selected frequency channel.

5. The method of claim 1, wherein:
the second frequency channel is on a second frequency band.

6. The method of claim 1, wherein:
the second frequency channel is on the first frequency band and does not overlap with the first frequency channel.

7. The method of claim 1, wherein analyzing the second frequency channel comprises:
measuring interference at the second frequency channel.

8. The method of claim 7, wherein analyzing the second frequency channel further comprises:
performing at least one of clear channel assessment (CCA) or dynamic frequency selection (DFS) for the second frequency channel.

9. The method of claim 1, wherein:
the effecting is implemented by a first communication circuit of a communication device, and
the analyzing is implemented by a second communication circuit of the communication device.

10. The method of claim 9, wherein:
the communication device is configured to switch between the first communication circuit and the second communication circuit for data communication.

11. The method of claim 9, wherein:
an overlap exists between one or more frequency bands supported by the first communication circuit and one or more frequency bands supported by the second communication circuit.

12. The method of claim 11, wherein the one or more frequency bands supported by the first communication circuit include the one or more frequency bands supported by the second communication circuit.

13. The method of claim 11, wherein the one or more frequency bands supported by the first communication circuit are same as the one or more frequency bands supported by the second communication circuit.

14. The method of claim 11, wherein the one or more frequency bands supported by the first communication circuit and the one or more frequency bands supported by the second communication circuit are within unlicensed spectrum.

15. The method of claim 14, wherein the one or more frequency bands supported by the first communication circuit or the one or more frequency bands supported by the second communication circuit include at least one of 2.4 GHz band or 5.8 GHz band.

16. A communication device, comprising:
a first communication circuit configured to effect data communication at a first frequency channel of a first frequency band; and
a second communication circuit configured to analyze a second frequency channel substantially concurrently with effecting the data communication.

17. The device of claim 16, wherein:
the second communication circuit is further configured to obtain an analyzing result from the analyzing of the second frequency channel; and
the device is configured to select a frequency channel based at least in part on the analyzing result; and continue the data communication at the selected frequency channel.

18. The device of claim 17 wherein:
the second communication circuit is further configured to select a candidate frequency channel based at least in part on the analyzing result; and
selecting the frequency channel comprises comparing the candidate frequency channel with the first frequency channel to determine the selected frequency channel.

19. The device of claim 18, wherein:
the second communication circuit is further configured to send information about the candidate frequency channel to the first communication circuit; and
the first communication circuit is further configured to determine whether to switch to the candidate frequency channel for continuing the data communication based on the information about the candidate frequency channel and information about the first frequency channel.

20. A mobile object, comprising:
a communication device configured to:
effect data communication at a first frequency channel of a first frequency band; and
analyze a second frequency channel substantially concurrently with effecting the data communication.
